(19) United States
(12) Patent Application Publication
(10) Pub. No.: US 2022/0111439 A1
(43) Pub. Date: Apr. 14, 2022

(54) THREE-DIMENSIONAL PRINTING OF OPTICAL MIRROR

(71) Applicant: Raytheon Company, Waltham, MA (US)

(72) Inventors: Scott R. Foes, Torrance, CA (US); Scott M. Balaban, Redondo Beach, CA (US)

(21) Appl. No.: 17/067,174

(22) Filed: Oct. 9, 2020

(51) Int. Cl. B22F 3/105; B33Y 10/00; B33Y 30/00; B33Y 80/00; B33Y 40/00; B23K 9/04

(52) U.S. Cl. CPC B22F 3/1055; B33Y 10/00; B33Y 30/00; B22F 2003/1058; B33Y 40/00; B23K 9/044; B33Y 80/00

(57) ABSTRACT

A method of fabricating an optical mirror including disposing a build plate for three-dimensional (3D) printing. The build plate having a first side and a second side opposite the first side. The method also including integrally forming a support structure via the 3D printing on the first side of the build plate, and processing the second side of the build plate to obtain a reflective surface of the optical mirror.

### BACKGROUND

The present disclosure relates to reflective optics and, more particularly, to the three-dimensional (3D) printing of an optical mirror.

Reflective optics (i.e., mirrors) are used in various applications. The optical mirrors may be part of sensors or may be used in imaging systems, for example. Optical mirrors are generally used to focus or deflect light. Some reflective materials (e.g., beryllium, silicon carbide) used in optical mirrors are considered exotic because of the expense and time involved in fabricating optical mirrors from them. Other non-exotic reflective materials include aluminum, steel, and titanium.

### SUMMARY

Disclosed herein are methods of fabricating an optical mirror. A non-limiting example of a method includes disposing a build plate for three-dimensional (3D) printing. The build plate has a first side and a second side opposite the first side. The method also includes integrally forming a support structure via the 3D printing on the first side of the build plate, and processing the second side of the build plate to obtain a reflective surface of the optical mirror.

Another non-limiting example of a structure includes a build plate used for three-dimensional (3D) printing, the build plate comprising a first side and a second side opposite the first side to be processed into a reflective layer. The structure also includes a support structure integrally formed on a portion of the first side of the build plate.

Additional features and advantages are realized through the techniques of the present disclosure. Other embodiments and aspects are described in detail herein and are considered a part of the claimed disclosure. For a better understanding of the disclosure with the advantages and the features, refer to the description and to the drawings.

### BRIEF DESCRIPTION OF THE SEVERAL VIEWS OF THE DRAWINGS

For a more complete understanding of this disclosure, reference is now made to the following brief description, taken in connection with the accompanying drawings and detailed description, wherein like reference numerals represent like parts:

FIGS. 1-7 illustrate aspects of the fabrication of a closed-back mirror via 3D printing according to one or more embodiments, in which:

FIG. 1 shows two surfaces of a reflective layer used as the build plate for forming the closed-back mirror;

FIG. 2 shows the result of forming an exemplary support structure on the reflective layer;

FIG. 3 shows the result of forming another exemplary support structure on the reflective layer;

FIG. 4 shows a cover used to sandwich the support structure, along with the reflective layer;

FIG. 5 shows the result of integrally forming mounting features on the cover;

FIG. 6 shows one side of the closed-back mirror; and

FIG. 7 shows the other side of the closed-back mirror which results from processing the reflective surface of the reflective layer used as the build plate.

### DETAILED DESCRIPTION

Embodiments of the systems and methods detailed herein relate to 3D printing of an optical mirror. Specifically, a reflective surface of the optical mirror is created from a build plate on which the support structure of the optical mirror is printed. The high level of reflectivity required for certain applications (e.g., space and tactical applications) has called for the use of exotic materials for use in optical mirrors. An approach to avoiding the expense and time associated with exotic materials has been the design of closed-back mirrors. In a closed-back design, the support structure behind the layer from which the reflective surface is created is closed in or sandwiched by a back cover. In an open-back design, the support structure is not closed in by a cover. Closed-back design, in particular, has benefited from prior implementation of 3D printing, also referred to as additive manufacturing. This is because the back cover has been used as the build plate. 3D printing may be implemented by many different techniques such as wire arc additive manufacturing (WAAM), powder-based metal additive manufacturing, and selective laser sintering (SLS), for example.

As previously noted, prior approaches to fabricating closed-back mirrors via 3D printing have built up from the back cover to the support structure and then added the layer from which the reflective surface is created. This order has resulted in porosity issues for the reflective surface that negatively affect reflectivity and has also affected stability over time. According to one or more embodiments, the layer in which the reflective surface is created is used as the build plate for the 3D printing. Thus, the order of fabrication is reversed such that the support structure is printed onto the back of the layer and, according to exemplary embodiments, the back cover is added. Because the back cover of a closed-back mirror is not used as the build plate, the 3D printing of optical mirrors according to one or more embodiments may be implemented with or without the back cover (i.e., open or closed-back optical mirrors may be fabricated). To fabricate an open-back optical mirror, the process of 3D printing the back cover is simply omitted.

The layer that is used as the build plate and from which the reflective surface is created, according to embodiments, may be aluminum, plastic, or any metal. This build plate layer is unaffected by the 3D printing. In addition to avoiding porosity and other issues for the build plate layer, the 3D printing according to one or more embodiments also allows complete freedom in designing the topology of the support structure and the placement and geometry of integral mounting features, as detailed. Thus, the topology of the support structure and the numbers, placement, and geometry of the mounting features may be optimized to achieve the strength and weight needed to support the size, material, and other characteristics that are desired for the optical mirror, as well as for the application for which the optical mirror is fabricated.

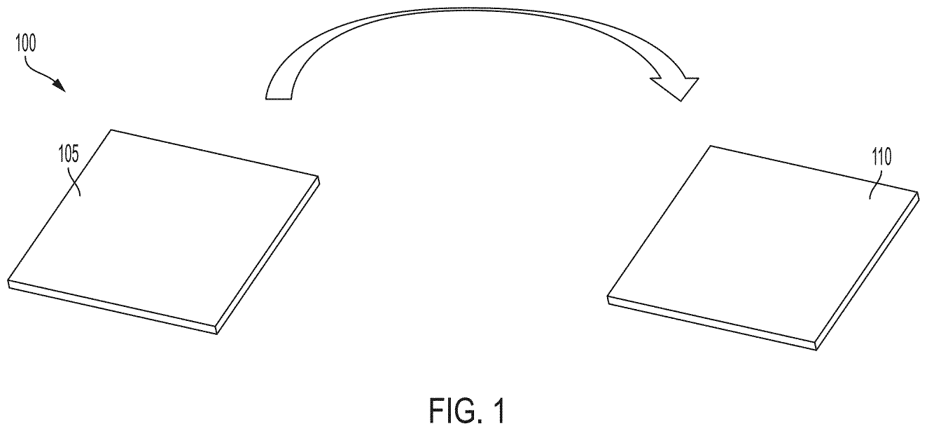

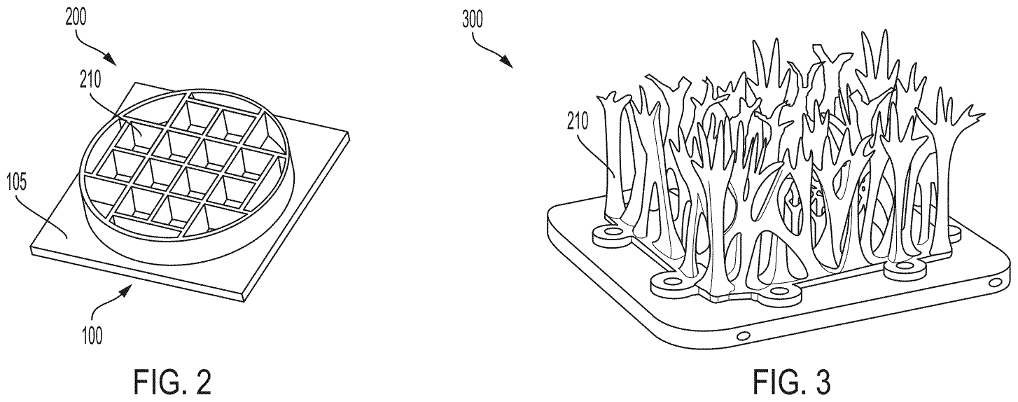

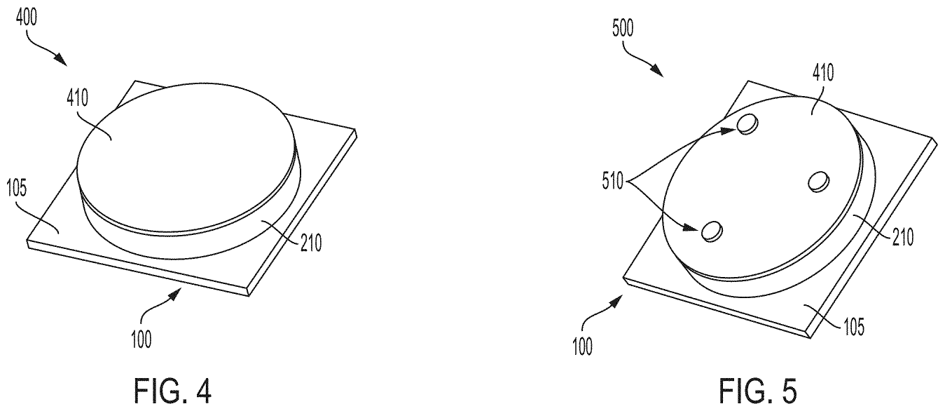

FIGS. 1-7 show different stages or intermediate structures in the fabrication of a closed-back optical mirror 700 (FIG. 7) using 3D printing according to one or more embodiments. In addition, the omission of stages discussed with reference to FIGS. 4 and 5 results in an open-back optical mirror. FIG. 1 shows two surfaces of a layer 100. While the exemplary layer 100 is shown as a square, the layer 100 may be any shape that accommodates formation of the other components of the closed-back mirror 700 (or an open-back mirror), as detailed. A build plate surface 105 of the layer 100 acts as the build plate for the 3D printing. That is, the support structure 210 (FIG. 2) and cover 410 (FIG. 4) are printed onto the build plate surface 105 of the layer 100. The surface 110 of the layer 100 is opposite the build plate surface 105 and is ultimately processed into the reflective surface 710 (FIG. 7). Reflective surface is used interchangeably with optical mirror herein. As previously noted, the embodiments discussed herein are not limited to a particular material for the layer 100. Because the layer 100 itself is not formed via 3D printing, any material (e.g., aluminum, plastic, or one of the previously noted exotic materials) may be used without porosity and stability issues.

FIG. 2 shows an intermediate structure 200 in the formation of the closed-back optical mirror 700 (FIG. 7) according to an exemplary embodiment. The intermediate structure 200 shows the support structure 210 that is formed on the build plate surface 105 of the layer 100 via 3D printing. As previously noted, the embodiments discussed herein are not limited to any particular type of 3D printing. The 3D printing process may include powder-based metal additive manufacturing, WAAM, or SLS, for example. The use of the layer 100 as the build plate for the 3D printing is what gives rise to the several improvements in the resulting closed-back optical mirror 700 over prior 3D printing-based closed-back mirrors. Further, any 3D printing process will ensure that the components formed on the layer 100 (i.e., build plate) are integrally formed, without brazing or any other affixing elements.

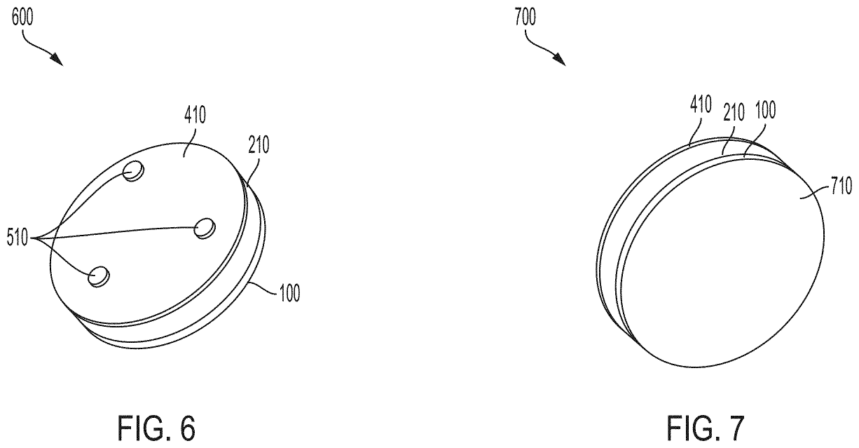

FIG. 3 shows an intermediate structure 300 according to another exemplary embodiment. Because the support structure 210 is formed by 3D printing, topologies, like the one shown in FIG. 3, may be achieved. Such irregular topologies are not possible via machining. As previously noted, the topology of the support structure 210 may be optimized to provide the strength and weight required for the size, material, and other characteristics that are desired for the closed-back optical mirror 700. According to alternate embodiments, FIGS. 2 and 3 represent exemplary intermediate structures 200, 300 in the fabrication of an open-back optical mirror. The processes discussed with reference to FIGS. 6 and 7 may then be performed to obtain the final structure with the reflective surface 710 (FIG. 7) and support structure 210 without a back cover 410 (FIG. 4). The topology of the support structure 210 may be adjusted to provide sufficient strength, without a back cover, to the ultimate open-back optical mirror.

FIG. 4 shows an intermediate structure 400 in the formation of the closed-back optical mirror 700 (FIG. 7) that results from formation of the cover 410. As previously noted, the support structure 210 is sandwiched between the layer 100 and this cover 410. Without this cover 410, the resulting mirror would be an open-back design.

FIG. 5 shows an intermediate structure 500 with mounting features 510 that are integrally formed on the cover 410 via the 3D printing. The mounting features 510 may be used to affix the closed-back optical mirror 700 (FIG. 7) to other components of a complete system used in a particular application. The three mounting features 510 shown in FIG. 5 are only one non-limiting example. Any number of mounting features 510 may be formed. Further, the 3D printing process maximizes flexibility in both the placement and geometry of these mounting features 510. The integral formation of the mounting features 510 addresses an issue that arises in the prior approach of building the closed-back mirror in the opposite order (i.e., the reflective layer is the last element formed). Affixing mounting features in a mirror fabricated according to the prior approach can result in print-through, which refers to the reflective surface being adversely affected by stress caused by the mounting features on the cover. When the 3D printing process according to one or more embodiments is used to fabricate an open-back mirror by omitting the 3D printing of the back cover 410, the mounting features 510 may be integrally formed on the support structure 210.

FIG. 6 shows an intermediate structure 600 that results from removing the excess portion of the layer 100. This intermediate structure 600 is obtained by cutting and machining the intermediate structure 500 shown in FIG. 5. Based on the 3D printing, the support structure 210, cover 410, and mounting features 510 are all integrally formed on the layer 100 (i.e., without any brazing or other affixing process), thereby maximizing integrity while facilitating the use of a lower-cost layer 100.

FIG. 7 shows the closed-back optical mirror 700 that results from processing the surface 110 of the layer 100 of the intermediate structure 600 to obtain the reflective surface 710. Any known process may be used to form the reflective surface 710 from the surface 110 of the layer 100. Generally, a rough machining process may be performed to remove porosity. This process may be followed by a stress relief procedure. The stress relief procedure involves heating the material to remove any residual stress (i.e., any potential subsequent deformation). This may be following by diamond turning, polishing, or a combination of the two. For example, diamond turning may be used when the layer 100 is aluminum or another metal, while polishing may be used when the layer 100 is plastic.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the embodiments or aspects in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain proper protection of the disclosure as first described.

What is claimed is:

1. A method of fabricating an optical mirror, the method comprising:
disposing a build plate for three-dimensional (3D) printing, wherein the build plate has a first side and a second side opposite the first side;
integrally forming a support structure via the 3D printing on the first side of the build plate;
processing the second side of the build plate to obtain a reflective surface of the optical mirror.

2. The method according to claim 1, further comprising determining a topology for the support structure based on a size and material of the mirror.

3. The method according to claim 1, further comprising, prior to the processing the second side of the build plate, integrally forming a cover, via the 3D printing, on a side of the support structure opposite a side integrally formed on the first side of the build plate such that the support structure is sandwiched between the cover and the build plate.

4. The method according to claim 3, further comprising integrally forming one or more mounting features on the cover.

5. The method according to claim 4, wherein a number, location, and geometry of the one or more mounting features is based on an application for which the mirror is fabricated.

6. The method according to claim 1, further comprising removing portions of the reflective layer on which the support structure is not formed.

7. The method according to claim 1, wherein the processing the second side of the build plate includes performing a rough machining process.

8. The method according to claim 7, wherein the processing the second side of the build plate includes performing a stress relief procedure following the rough machining process.

9. The method according to claim 8, wherein the performing the stress relief procedure includes heating to remove residual stress in a material of the build plate.

10. The method according to claim 8, wherein the processing the second side of the build plate includes diamond turning, polishing, or a combination of both following the stress relief procedure.

11. The method according to claim 1, wherein the disposing the build plate includes disposing a layer of aluminum.

12. The method according to claim 1, wherein the disposing the build plate includes disposing a layer of plastic.

13. The method according to claim 1, wherein the 3D printing is wire arc additive manufacturing (WAAM).

14. The method according to claim 1, wherein the 3D printing is powder-based metal additive manufacturing.

15. The method according to claim 1, wherein the 3D printing is selective laser sintering (SLS).

16. A structure comprising:
a build plate used for three-dimensional (3D) printing, the build plate comprising a first side and a second side opposite the first side to be processed into a reflective layer; and
a support structure integrally formed on a portion of the first side of the build plate.

17. The structure according to claim 16, wherein a topology of the support structure is integrally formed based on a size and material of the portion of the build plate.

18. The structure according to claim 16, further comprising a cover integrally formed on the support structure such that the support structure is sandwiched between the cover and the first side of the build plate.

19. The structure according to claim 18, further comprising one or more mounting features integrally formed on the cover.

20. The structure according to claim 16, wherein the build plate includes aluminum or plastic.
